(19) United States
(12) Patent Application Publication
(10) Pub. No.: US 2026/0299285 A1
(43) Pub. Date: Oct. 1, 2026

(54) INDUSTRIAL DEVICE WITH SEALING AND LIGHT-TRANSMITTING LENS AND FORMING METHOD

(71) Applicant: ROCKWELL AUTOMATION TECHNOLOGIES, INC., Mayfield Heights, OH (US)

(72) Inventors: Arkadiusz Gros, Katowice (PL); Krzysztof Jackowski, Katowice (PL); Piotr Krawiec, Katowice (PL)

(73) Assignee: ROCKWELL AUTOMATION TECHNOLOGIES, INC., Mayfield Heights, OH (US)

(21) Appl. No.: 19/093,084

(22) Filed: Mar. 27, 2025

(51) Int. Cl. G02B 27/00

(52) U.S. Cl. CPC G02B 27/0006

(57) ABSTRACT

An industrial device includes a housing defining a cavity and comprising a cover. The cover includes a first surface, a second surface, and a lens housing portion extending between the first surface and the second surface, the lens housing portion including a receptacle to house a lens. The receptacle includes a first end and a second end, the first end comprising a rear wall and a rear protrusion extending from the rear wall to form a top rear interface configured to oppose a first compressive force during formation of the lens to secure the lens within the receptacle. The receptacle further includes a first side comprising a lateral wall and a lateral protrusion extending from the lateral wall to form a first rear lateral interface configured to oppose a second compressive force during the formation of the lens to secure the lens within the receptacle.

### BACKGROUND

The present disclosure relates generally to a housing for an industrial device, and more particularly to a cover for a device having lenses within the cover.

Covers for devices may be fabricated by installing lenses into caverns in the cover. For example, traditional techniques may include applying an adhesive to the edges of the caverns of the cover, preparing the lenses for installation, pressing the lenses onto the adhesive and/or into the caverns, applying pressure to the lenses and/or hardening the adhesives to stabilize the lenses. However, traditional fabrication techniques often result in stability issues (e.g., tightness or inadequate fit between the lenses and the caverns, etc.), appearance defects (e.g., visible traces of adhesives, which obscure visibility through the cover, etc.), require repeat fabrication steps (e.g., due to inadequate implementation, etc.), and/or result in high resource consumption (e.g., labor, energy, costs, etc.). As such, it would be beneficial to have a device housing (e.g., cover with lenses, etc.) that address these issues associated with traditional device covers and methods of fabricating them.

### SUMMARY

One implementation of the present disclosure is an industrial device. The industrial device includes a housing defining a cavity, the housing having a cover. The cover includes a first surface, a second surface opposite the first surface, and a lens housing portion extending between the first surface and the second surface, the lens housing portion including at least one receptacle to house at least one lens. The at least one receptacle includes a first end and a second end opposite the first end, the first end comprising a rear wall and a rear protrusion extending from the rear wall to form a top rear interface, the top rear interface configured to oppose a first compressive force during formation of the at least one lens to secure the at least one lens within the at least one receptacle. The at least one receptacle further includes a first side comprising a first lateral wall and a first lateral protrusion extending from the first lateral wall to form a first rear lateral interface, the first rear lateral interface configured to oppose a second compressive force during the formation of the at least one lens to secure the at least one lens within the at least one receptacle.

Another implementation of the present disclosure is a lens for an industrial device. The lens includes a first end and a second end opposite the first end, the first end comprising a first rear wall portion, a second rear wall portion, and a rear interlock aperture between the first rear wall portion and the second rear wall portion, the rear interlock aperture formed during a molding process, and the rear interlock aperture configured to receive a rear protrusion of a receptacle of the drive device to secure the lens within the receptacle. The lens further includes a first side comprising a first lateral wall portion, a second lateral wall portion, and a channel between the first lateral wall portion and the second lateral wall portion, the channel formed during the molding process, and the channel configured to receive a lateral protrusion of the receptacle of the drive device to secure the lens within the receptacle.

Another implementation of the present disclosure is a method of forming a lens of a cover of an industrial device. The method includes positioning the cover relative to at least one plate of a machining device, where the at least one plate comprises a delivery opening configured to be aligned with an opening in a bottom surface of the cover, and securing the at least one plate relative to the cover. The method further includes providing fabrication material to form at least one lens within the cover, where providing the fabrication material includes injecting the fabrication material through the delivery opening and the opening in the bottom surface of the cover to a cavity formed between the cover and the at least one plate. The method also includes allowing the fabrication material to form, where during formation of the fabrication material the fabrication material causes one or more compressive forces to be applied to one or more surfaces of the cover, the one or more surfaces configured to oppose the one or more compressive forces to form the at least one lens and secure the at least one lens relative to the cover, and removing to cover from the at least one plate.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drive device of a servo system, according to some embodiments.

FIG. 2 is a top view of a cover of the drive device of FIG. 1, according to some embodiments.

FIG. 3 is a bottom view of a cover of the drive device, according to some embodiments.

FIG. 4 is a top perspective view of a cover of the drive device of FIG. 1, according to some embodiments.

FIG. 5 is a cross-sectional side perspective view of a portion of a cover of the drive device of FIG. 1, according to some embodiments.

FIG. 6 is a cross-sectional side view of a process of forming a lens of a cover of the drive device of FIG. 1, according to some embodiments.

FIG. 7 is a perspective view of a lens of the drive device of FIG. 1, according to some embodiments.

FIG. 8 is a side view of a lens of the drive device of FIG. 1, according to some embodiments.

FIG. 9 is a side view of a lens of the drive device of FIG. 1, according to some embodiments.

FIG. 10 is a cross-sectional side view of a lens of the drive device of FIG. 1, according to some embodiments.

FIG. 11 is a process for forming a lens of the drive device of FIG. 1, according to some embodiments.

### DETAILED DESCRIPTION

### Overview

Referring generally to the FIGURES, systems and methods for fabricating one or more components of a housing of an industrial device are shown, according to an exemplary embodiment. In an exemplary embodiment, the systems and methods described herein are implemented to form a lens within an industrial device (e.g., a cover of a device, etc.) used in an industrial setting. Examples of such industrial devices include drive devices (e.g., actuators, servos, etc.), controllers (e.g., field controllers, supervisory controllers, etc.), sensors (e.g., wired or wireless sensors configured to measure any variable state or condition of an industrial environment), networking devices (e.g., routers, switches, gateways, junction boxes, etc.), or any other type of industrial device which can be used in an industrial setting. The lens may be formed via a fabrication process (e.g., injection molding, single-step injection molding, etc.), which results in a lens having a plurality of interlocking and/or connection features, which otherwise would be difficult to fabricate and/or machine. Advantageously, the components of the cover and/or lens described herein (e.g., the interlocking, connection, etc. features) result in engagements between the lenses and the cover (e.g., each receptacle, etc.), which results in improved stability between the components (e.g., tightness, sealing, reduced leakage, etc.), reduces appearance defects (e.g., removes the need for additional adhesive products, etc.), improves fabrication processes (e.g., reduces repeat fabrication steps, etc.), and/or reduces resource consumption (e.g., labor, costs, energy consumption, etc.).

While the systems and methods of the present disclosure are described primarily with reference to a drive device for ease of explanation, it should be understood that this is merely one example and should not be regarded as limiting. It is contemplated that the systems and methods of the present disclosure can be used in any of a variety of applications across the industry. For example, the systems and methods described herein can be used to fabricate any type of device or structure in which a metal cover, lid, or wall, requires a light-indicating method to display information to the operator (e.g., status, errors, or processes). Accordingly, it should be understood that while the systems and methods described herein are described with reference to a component of an industrial device (e.g., a cover of a housing of a drive device, etc.), it is contemplated that the components, systems, and/or methods described herein may be implemented in various components, devices, and/or systems of any suitable industry and/or application, for example where information is visualized (e.g., light-emitting, light-indication, etc.) using one or more lenses.

For example, the systems and methods described herein may be implemented with one or more components of any suitable housing, container, receptacle, repository, and/or vessel. The housing may include one or more components (e.g., a wall, a surface, a boundary, a base, a lid, a cover, etc.) that may be formed of a metal or metal alloy (e.g., ferrous metal, non-ferrous metal, etc.). Further, the housing may be implemented to form one or more lenses within one or more components of the housing, for example to facilitate visualizing information. In this regard, it should be understood that the systems and methods described herein may be implemented to form a lens within any one or more components (e.g., a wall, surface, boundary, base, lid, cover, etc.) of any suitable housing (e.g., container, receptacle, repository, vessel, etc.) that may be implemented with a device, system, and/or process across a variety of industries and/or applications (e.g., automation, robotics, manufacturing, electronics, vehicles, satellite tracking, aeronautics, etc.).

As an exemplary embodiment, and as described herein, an “actuator” or “system” (e.g., a “servo system,” etc.) may refer to a control system of one or more mechanical systems. More specifically, a “servo system” may be implemented to control a position and/or its time derivatives (e.g., velocity, speed, torque, etc.) of one or more components of a mechanical system. According to an exemplary embodiment, servo systems may be implemented to provide precise control of one or more mechanical components in various industrial applications (e.g., robotics, manufacturing, automation, satellite tracking, aeronautics, etc.).

Conventional servo systems include an actuator (e.g., a servo motor, etc.), a control device, and a feedback element. In some embodiments, the servo system includes a “servo drive,” which is configured to receive a command signal (e.g., from the control device), modify the signal (e.g., amplify the signal), and transmit the command signal to the actuator to produce a desired property within the servo system. According to an exemplary embodiment, the servo drive is configured to communicate command signals to the actuator to achieve a desired property of one or more mechanical components (e.g., velocity, torque, position, etc.). The servo drive may also be configured to receive one or more feedback signals from the actuator (e.g., a sensor of the actuator). In an exemplary embodiment, the servo drive is further configured to receive the feedback signal, compare the actual operating conditions to command operating conditions, and/or modify (e.g., adjust, etc.) the command signals communicated to the actuator, for example to achieve desired actual operating conditions.

As will be discussed herein, conventional servo drives include a housing configured to house one or more components of the servo drive device. The housing may be formed of metal or a metal alloy (e.g., steel, stainless steel, etc.), and may include a cover having one or more lenses that facilitate visualizing components within the housing. Traditional covers for servo devices may be fabricated by installing lenses into caverns in the cover. More specifically, traditional fabrication techniques may include applying an adhesive to the edges of the caverns of the cover, preparing the lenses for installation (e.g., hard-painting a bottom of the lens, etc.), and then pressing the lenses onto the adhesive and/or into the caverns. Once in place, pressure may be applied to the lenses (e.g., via a clamping device, etc.) to position the lenses, and the adhesive may be hardened (e.g., via ultraviolet hardening techniques, etc.) to stabilize the lenses.

However, traditional fabrication techniques often result in stability issues (e.g., tightness or inadequate fit between the lenses and the caverns in the cover, etc.), appearance defects (e.g., visible traces of adhesives, which obscure visibility into the servo drive device, etc.), require repeat fabrication steps (e.g., due to inadequate implementation, etc.), and/or result in high resource consumption (e.g., labor, energy, costs, etc.). Further, other machining and/or fabrication techniques (e.g., overmolding, multi-part machining applications, etc.) may result in components (e.g., lenses, etc.) that include several pieces and/or interfaces, which may also result in stability issues, result in repeat fabrication steps, and/or result in high resource consumption. As such, the systems and methods described herein address the issues presented by traditional techniques of fabricating components of servo drive devices (e.g., installing lenses or other components, etc.), for example by providing systems and methods that implement lenses using a fabrication process (e.g., injection molding, a single-step injection molding process, etc.) that results in improved stability (e.g., tightness, sealing, etc.) between the lenses and the cover (e.g., the metal material, etc.), reduces appearance defects, improves fabrication processes, and/or reduces resource consumption (e.g., labor, costs, energy consumption, etc.).

### Servo Drive Device

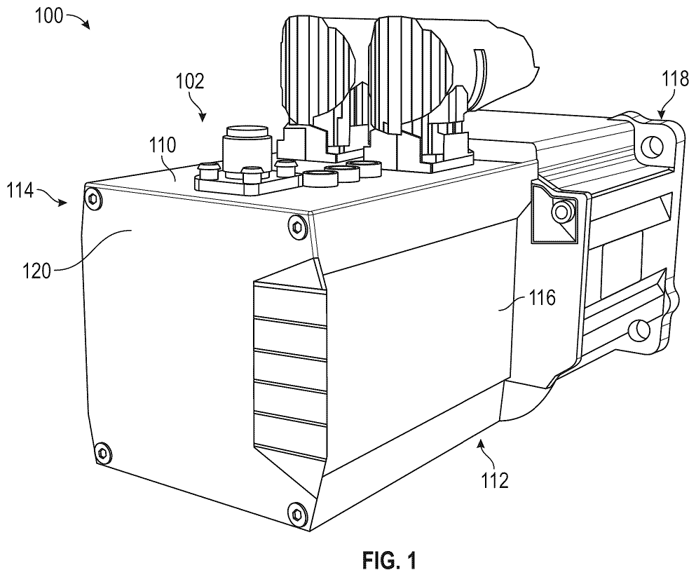

Referring generally to FIG. 1, a drive device of a control system is shown, according to an exemplary embodiment. In an exemplary embodiment, the drive device, shown as a device 100, is a servo drive device of a servo system, as described herein. As shown, the device 100 includes a housing 102 configured to house one or more components of the device 100 (e.g., electrical, mechanical, electromechanical, processing, computing, etc. devices).

As shown in FIG. 1, the housing 102 includes a first side or wall, shown as a top 110, and a second side or wall, shown as a bottom 112, opposite the top 110. The housing 102 may include a third side or wall, shown as a first side 114, and a fourth side or wall, shown as a second side 116, opposite the first side 114. The top 110, the bottom 112, the first side 114, and the second side 116 may be coupled to form the housing 102. As shown in FIG. 1, the housing 102 may further include a first end, shown as a base 118, and a second end, shown as a cover 120, opposite the base 118. The base 118 and the cover 120 may be coupled with the top 110, the bottom 112, the first side 114, and/or the second side 116, for example to form the housing 102.

In an exemplary embodiment, the components of the housing 102 are coupled, for example to define a cavity (e.g., within the housing 102, etc.) to house one or more components of the device 100. The components of the housing 102 may be coupled via a fastener (e.g., screw, pin, bolt, etc.), may be welded or machined, and/or may be otherwise coupled. According to an exemplary embodiment, one or more components of the housing 102 are formed of metal or metal alloy (e.g., steel, aluminum, iron, stainless steel, brass, etc.). For example, one or more components of the housing 102 may be formed of a ferrous metal (e.g., carbon steel, silicon steel, galvanized steel, permalloy, etc.), a non-ferrous metal (e.g., copper, tin, zinc, bronze, magnesium, titanium, gold, bronze, etc.), and/or another suitable metal or metal alloy. In other embodiments, the housing 102 is formed of another suitable material and/or is otherwise arranged or configured.

It should be understood that while one or more of the components and/or methods described herein are described in reference to the cover 120, it is contemplated that any and/or all of the components and/or methods may be implemented with any and/or all of the components of the housing 102 (e.g., the top 110, the bottom 112, the first side 114, the second side 116, the base 118, etc.). In this sense, it is contemplated that the components of the cover 120 and/or the methods applied thereto, as described herein, may be implemented with any and/or all of the components of the housing 102 (e.g., top 110, the bottom 112, the first side 114, the second side 116, the base 118, etc.).

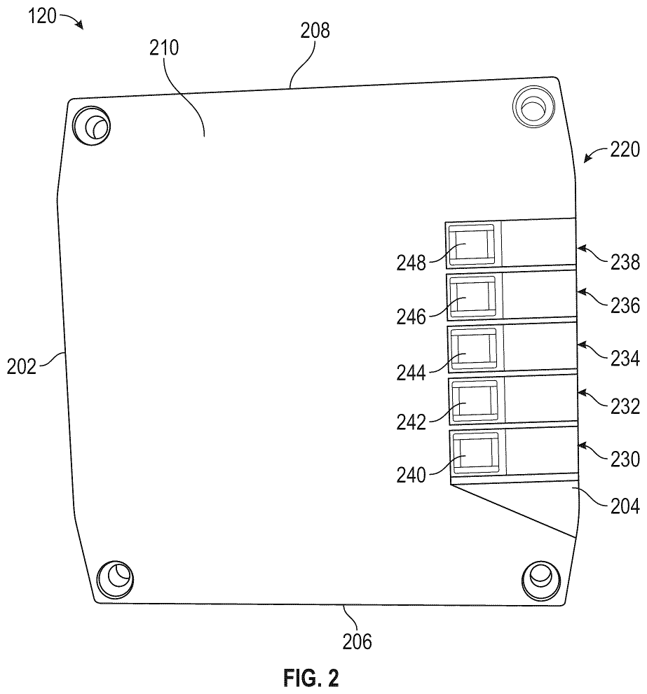

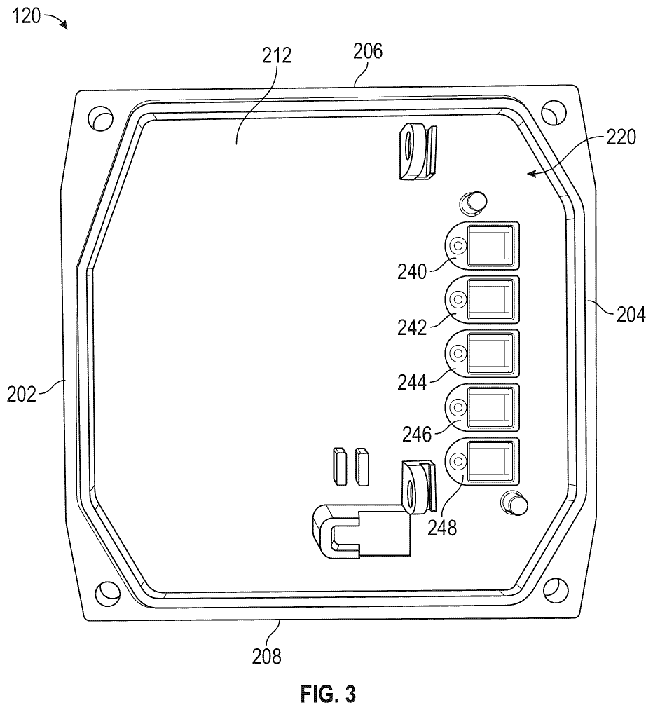

Referring generally to FIGS. 2-4, the cover 120 of the device 100 of FIG. 1 is shown in greater detail, according to an exemplary embodiment. As shown in FIGS. 2-3, the cover 120 includes a first side or edge, shown as a first side 202, a second side or edge, shown as a second side 204, opposite the first side 202. The cover 120 also includes a third side or edge, shown as a third side 206, extending between the first side 202 and the second side 204. The cover 120 further includes a fourth side or edge, shown as a fourth side 208, extending between the first side 202 and the second side 204, and opposite the third side 206. In an exemplary embodiment, the cover 120 is defined by the first side 202, the second side 204, the third side 206, and the fourth side 208.

In an exemplary embodiment, the cover 120 includes a first surface, shown as a top surface 210 (e.g., as shown in at least FIG. 2) and a second surface, shown as a bottom surface 212 (e.g., as shown in at least FIG. 3), opposite the top surface 210. The top surface 210 and the bottom surface 212 may be spaced a distance apart, for example to define a thickness of the cover 120. The cover 120 is further shown to include a lens housing region or portion, shown as a lens housing portion 220. The lens housing portion 220 may be positioned at an edge or side of the cover 120 (e.g., the second side 204), and/or may extend (e.g., span, etc.) between the top surface 210 and the bottom surface 212.

According to an exemplary embodiment, and as described herein, the lens housing portion 220 may be configured to house (e.g., contain, receive, couple, stabilize, form, define, etc.) one or more portions of at least one lens. For example, the lens housing portion 220 may include one or more components (e.g., one or more receptacles, etc.) having components configured to facilitate forming at least one lens (e.g., via a molding process, an injection molding process, etc.). In an exemplary embodiment, and as will be described herein, one or more components of the lens housing portion 220 is/are configured to oppose one or more compressive forces (e.g., a shrinkage force, an expansion force, etc.), for example during fabrication of the one or more lenses, for example to secure the lenses within the lens housing portion 220.

In some embodiments, the lens housing portion 220 is positioned at another suitable location of the cover 120. For example, the lens housing portion 220 may be positioned at a central region or portion of the cover 120 (e.g., between the first side 202 and the second side 204, between the third side 206 and the fourth side 208, etc.), may be positioned at central region of the cover 120 offset from an edge or side of the cover 120 (e.g., the first side 202, the second side 204, the third side 206, etc.). In some embodiments, the cover 120 includes a plurality of lens housing portions 220, which may be positioned at any suitable location of the cover 120.

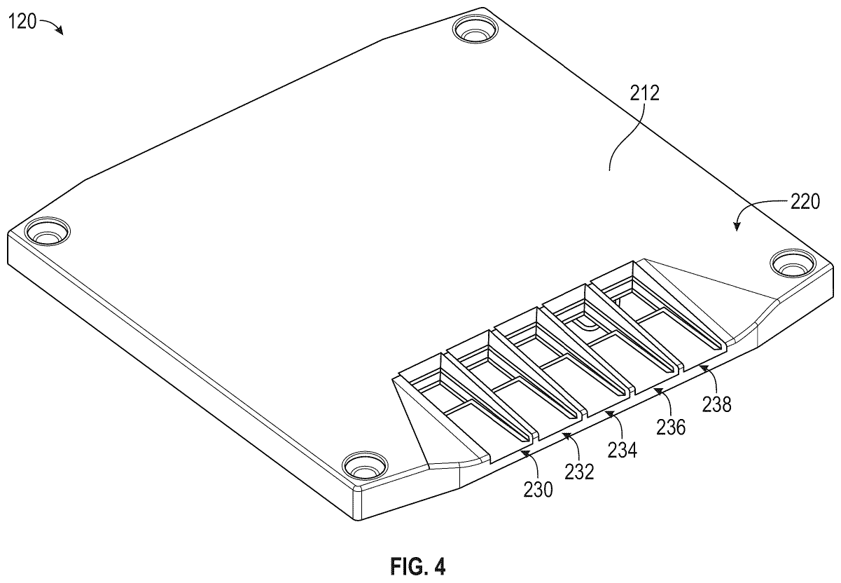

According to an exemplary embodiment, the lens housing portion 220 includes at least one receiver, receptacle, or housing component. For example, the lens housing portion 220 is shown to include a first receptacle 230, a second receptacle 232, a third receptacle 234, a fourth receptacle 236, and a fifth receptacle 238 (e.g., as shown in at least FIG. 4). According to an exemplary embodiment, each receptacle is configured to house (e.g., contain, receive, couple, stabilize, form, define, etc.) one or more portions of a lens. For example, the first receptacle 230 may be configured to house a first lens 240, the second receptacle 232 may be configured to house a second lens 242, the third receptacle 234 may be configured to house a third lens 244, the fourth receptacle 236 may be configured to house a fourth lens 246, and the fifth receptacle 238 may be configured to house a fifth lens 248 (e.g., as shown in at least FIGS. 2-3).

According to an exemplary embodiment, and as described herein, each receptacle may include components configured to facilitate forming (e.g., via injection molding, etc.) a lens housed therein. For example, each receptacle may include one or more components (e.g., surfaces, walls, voids, apertures, etc.) that facilitate forming a lens (e.g., via a molding process, an injection molding process, etc.). In an exemplary embodiment, each receptacle includes one or more components that is/are configured to oppose one or more forces provided during fabrication of the lens (e.g., a compressive force, a shrinkage force, an expansion force, etc.), for example to secure the lens within the respective receptacle.

It should be understood that while the cover 120 is described herein as being configured to house five lenses, it is contemplated that in other embodiments the cover 120 is configured to house any other suitable number of lenses (e.g., one, two, three, ten, etc.). Further, it should be understood that while the lens housing portion 220 is described herein as having components configured to facilitate forming five lenses of an exemplary configuration, it is contemplated that in other embodiments the lens housing portion 220 is configured to facilitate forming any other suitable number of lenses (e.g., one, two, three, ten, etc.) having any other suitable shape, size, and/or configuration.

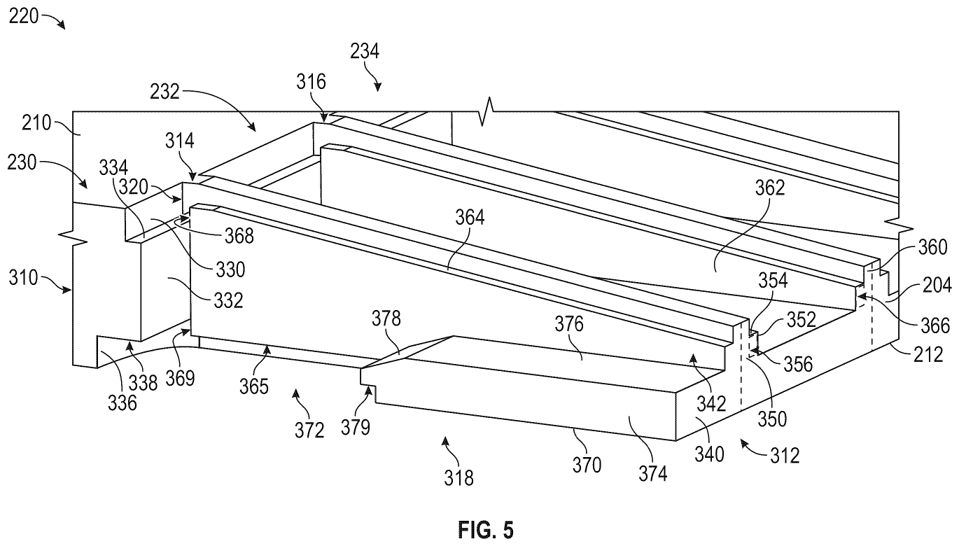

Referring now to FIG. 5, a portion of the cover 120 of the device 100 of FIG. 1 is shown in greater detail, according to an exemplary embodiment. More specifically, FIG. 5 illustrates a cross-sectional, perspective view of a plurality of receptacles (e.g., the first receptacle 230, the second receptacle 232, the third receptacle 234, etc.) of the lens housing portion 220, according to an exemplary embodiment. According to an exemplary embodiment, FIGS. 4-5 illustrate the features of the lens housing portion 220, for example prior to forming (e.g., injection molding, etc.) at least one lens. It should be understood that while one or more components of each receptacle are described with reference to one or more receptacles (e.g., the first receptacle 230, the second receptacle 232, the third receptacle 234, etc.) shown in FIG. 5, each receptacle described herein may comprise the same or similar features. Accordingly, any components or features of “the receptacle” described with reference to FIG. 5, or otherwise throughout the present disclosure, should be understood as components or features of any or all of the first receptacle 230, the second receptacle 232, the third receptacle 234, etc.

As shown in FIG. 5, the receptacle includes a first end, shown as a first end 310, and a second end, shown as a second end 312, opposite the first end 310 (e.g., as shown in the first receptacle 230). In some embodiments, the first end 310 is a rear or back end, and the second end 312 is a front or edge end. The receptacle further includes a first side, shown as a first side 314, and a second side, shown as a second side 316, opposite the first side 314 (e.g., as shown in the receptacle 232). In some embodiments, the first side 314 is a first lateral side, and the second side 316 is a second lateral side, opposite the first lateral side. The first side 314 and/or the second side 316 may extend between the first end 310 and the second end 312. The receptacle also includes a third side, shown as a bottom 318, and a fourth side, shown as a top 320, opposite the bottom 318 (e.g., as shown in the first receptacle 230). The bottom 318 and/or the top 320 may extend between the first end 310 and the second end 312. According to an exemplary embodiment, each receptacle is defined by a first end (e.g., the first end 310), a second end (e.g., the second end 312), a first side (e.g., the first side 314), a second side (e.g., the second side 316), a third side (e.g., the bottom 318) and a fourth side (e.g., the top 320), for example as shown in FIGS. 4-5.

As shown in FIG. 5, the first end 310 includes a surface or face, shown as a rear wall, and a projection or protrusion, shown as a rear protrusion 332, which extends from the rear wall. The rear wall is shown to include a first rear wall portion 330 and a second rear wall portion 336, where the rear protrusion 332 extends from and/or between the first rear wall portion 330 and the second rear wall portion 336 (e.g., as shown in the first receptacle 230). The rear protrusion 332 may extend from the first rear wall portion 330 and/or the second rear wall portion 336 (e.g., toward the second end 312) to form at least one ridge, shelf, or interface. For example, the rear protrusion 332 may extend from the first rear wall portion 330 to form a top rear interface 334, and/or the rear protrusion 332 may extend from the second rear wall portion 336 to form a bottom rear interface 338.

According to an exemplary embodiment, and as will be described herein, the components of the first end 310 (e.g., the first rear wall portion 330, the second rear wall portion 336, the rear protrusion 332, the top rear interface 334, the bottom rear interface 338, etc.) may be arranged to facilitate forming one or more components of a lens (e.g., via an injection molding process, etc.). For example, the components of the first end 310 may be configured to facilitate forming (e.g., via an injection molding process, etc.) one or more projections, surfaces, and/or voids of a lens. As discussed herein, the lens may be formed by providing (e.g., injecting, etc.) a fabrication material to a receptacle, and once the fabrication material is formed (e.g., hardened, solidified, etc.), the components of the first end 310 facilitate forming associated components of the lens.

In an exemplary embodiment, during the lens formation process the components of the first end 310 may be configured to oppose one or more forces provided during formation of the lens (e.g., a compressive force, a shrinkage force, an expansion force, etc.), for example to secure (e.g., couple, stabilize, etc.) the lens within the receptacle. For example, the top rear interface 334 may be configured to oppose a first compressive force (e.g., a shrinkage force in a vertical, downward direction, etc.) and the bottom rear interface 338 may be configured to oppose a second compressive force (e.g., a shrinkage force in a vertical, upward direction, etc.), for example to stabilize (e.g., form, define, etc.) a rear portion of the lens relative to the first end 310. Similarly, the first rear wall portion 330, the second rear wall portion 336, and/or a surface of the rear protrusion 332 may be configured to oppose one or more compressive forces (e.g., a shrinkage force, an expansion force, etc. in a horizontal, rearward direction, etc.), for example to stabilize (e.g., form, define, etc.) the rear portion of the lens relative to the first end 310.

The second end 312 is shown to include a surface or face, shown as front surface 340, and an opening or void, shown as opening 342 (e.g., as shown in the first receptacle 230). The front surface 340 may be defined by and/or a part of the second side 204. The opening 342 may be configured provide a space or void at the second end 312 of a receptacle, for example to facilitate forming a lens, as described herein.

As shown in FIG. 5, the first side 314 includes a first wall, surface, or face, shown as a first lateral wall 350 (e.g., as shown in the second receptacle 232). The first lateral wall 350 may extend from the first end 310 to the second end 312. In an exemplary embodiment, the first lateral wall 350 extends from the first end 310 to the second end 312 at an angle, for example at an angle from the top surface 210 toward the bottom surface 212 (e.g., as shown in the second receptacle 232). The first side 314 is shown to include a projection or protrusion, shown as a first lateral protrusion 352, which extends from the first lateral wall 350 (e.g., as shown in the second receptacle 232).

In an exemplary embodiment, the first lateral protrusion 352 extends from the first lateral wall 350 to form at least one ridge, shelf, or interface. For example, the first lateral protrusion 352 may extend from the first lateral wall 350 to form a top lateral interface 354, a bottom lateral interface 355, a front lateral interface 356, a first rear lateral interface 358, and a second rear lateral interface 359. The top lateral interface 354 may extend along a top portion of the first lateral protrusion 352, and the bottom lateral interface 355 may extend along a bottom portion of the first lateral protrusion 352 (e.g., on opposing top and bottom portions of the first lateral protrusion 352, etc.). The front lateral interface 356 may be positioned at a front portion of the first lateral protrusion 352 (e.g., at the front surface 340, the second end 312, etc.), and the first rear lateral interface 358 and/or the second rear lateral interface 359 may be positioned at a rear portion of the first lateral protrusion 352 (e.g., at the first end 310, toward the first rear wall portion 330, toward the second rear wall portion 336, etc.). In an exemplary embodiment, the first rear lateral interface 358 is positioned a first distance from the rear wall (e.g., the first rear wall portion 330, etc.), for example to form a space or void at the first end 310. Similarly, the second rear lateral interface 359 may be positioned a second distance from the rear wall (e.g., the second rear wall portion 336, etc.), for example to form a space or void at the first end 310.

According to an exemplary embodiment, and as will be described herein, the components of the first side 314 (e.g., the first lateral wall 350, the first lateral protrusion 352, the top lateral interface 354, the bottom lateral interface 355, the front lateral interface 356, the first rear lateral interface 358, the second rear lateral interface 359, etc.) may be arranged to facilitate forming one or more components of a lens (e.g., via an injection molding process, etc.). For example, the components of the first side 314 may be configured to facilitate forming (e.g., via an injection molding process, etc.) one or more projections, surfaces, and/or voids of a lens (e.g., at a first side of the lens, etc.). As discussed herein, the lens may be formed by providing (e.g., injecting, etc.) a fabrication material to a receptacle, and once the fabrication material is allowed to form (e.g., harden, solidify, etc.), the components of the first side 314 facilitate forming associated components of a side of the lens.

In an exemplary embodiment, during the lens formation process the components of the first side 314 may be configured to oppose one or more forces provided during formation of the lens (e.g., a compressive force, a shrinkage force, an expansion force, etc.), for example to secure (e.g., couple, stabilize, etc.) the lens within the receptacle. For example, the top lateral interface 354 may be configured to oppose a first compressive force (e.g., a shrinkage force in a vertical, downward direction, etc.) and the bottom lateral interface 355 may be configured to oppose a second compressive force (e.g., a shrinkage force in a vertical, upward direction, etc.), for example to stabilize (e.g., form, define, etc.) a first lateral portion or side of the lens relative to the first side 314. Further, the front lateral interface 356 may be configured to oppose one or more compressive forces (e.g., a shrinkage force, etc. in a horizontal, rearward or back direction, etc.), for example to stabilize (e.g., form, define, etc.) a front portion (e.g., a lip or ridge, etc.) of the lens relative to the second side 316.

In an exemplary embodiment, the first rear lateral interface 358 is configured to oppose one or more compressive forces (e.g., a shrinkage force, etc. in a horizontal, forward or front direction, etc.), for example to stabilize (e.g., form, define, etc.) a first rear lateral portion of the lens relative to the first side 314. Similarly, in an exemplary embodiment the second rear lateral interface 359 is configured to oppose one or more compressive force (e.g., a shrinkage force, etc. in a horizontal, forward or front direction, etc.), for example to stabilize (e.g., form, define, etc.) a second rear lateral portion of the lens relative to the first side 314. In this sense, the rear lateral interfaces (e.g., the first rear lateral interface 358, the second rear lateral interface 359, etc.) may be configured to facilitate forming one or more connection components of a lens, for example by opposing compressive forces during a lens fabrication process, to facilitate stabilizing a rear lateral portion of the lens relative to the first side 314.

As also shown in FIG. 5, the second side 316 includes a second wall, surface, or face, shown as a second lateral wall 360 (e.g., as shown in the second receptacle 232). The second lateral wall 360 may be opposite the first lateral wall 350. Similar to the first lateral wall 350, the second lateral wall 360 may extend from the first end 310 to the second end 312. For example, the second lateral wall 360 is shown to extend from the first end 310 to the second end 312 at an angle, for example at an angle from the top surface 210 toward the bottom surface 212 (e.g., as shown in the second receptacle 232). The second side 316 is shown to include a projection or protrusion, shown as a second lateral protrusion 362, which extends from the second lateral wall 360 (e.g., as shown in the second receptacle 232).

In an exemplary embodiment, the second lateral protrusion 362 extends from the second lateral wall 360 to form at least one ridge, shelf, or interface. For example, the second lateral protrusion 362 may extend from the second lateral wall 360 to form a top lateral interface 364, a bottom lateral interface 365, a front lateral interface 366, a first rear lateral interface 368, and a second rear lateral interface 369. The top lateral interface 364 may extend along a top portion of the second lateral protrusion 362, and the bottom lateral interface 365 may extend along a bottom portion of the second lateral protrusion 362 (e.g., on opposing top and bottom portions of the second lateral protrusion 362, etc.). The front lateral interface 366 may be positioned at a front portion of the second lateral protrusion 362 (e.g., at the front surface 340, the second end 312, etc.), and the first rear lateral interface 368 and/or the second rear lateral interface 369 may be positioned at a rear portion of the second lateral protrusion 362 (e.g., at the first end 310, toward the first rear wall portion 330, toward the second rear wall portion 336, etc.). In an exemplary embodiment, the first rear lateral interface 368 is positioned a first distance from the rear wall (e.g., the first rear wall portion 330, etc.), for example to form a space or void at the first end 310 (e.g., as shown in the first receptacle 230). Similarly, the second rear lateral interface 369 may be positioned a second distance from the rear wall (e.g., the second rear wall portion 336, etc.), for example to form a space or void at the first end 310 (e.g., as shown in the first receptacle 230).

According to an exemplary embodiment, and as will be described herein, the components of the second side 316 (e.g., the second lateral wall 360, the second lateral protrusion 362, the top lateral interface 364, the bottom lateral interface 365, the front lateral interface 366, the first rear lateral interface 368, the second rear lateral interface 369, etc.) may be arranged to facilitate forming one or more components of a lens (e.g., via an injection molding process, etc.). For example, the components of the second side 316 may be configured to facilitate forming (e.g., via an injection molding process, etc.) one or more projections, surfaces, and/or voids of a lens (e.g., at a second side of the lens, etc.). As discussed herein, the lens may be formed by providing (e.g., injecting, etc.) a fabrication material to a receptacle, and once the fabrication material is allowed to form (e.g., harden, solidify, etc.), the components of the second side 316 facilitate forming associated components of a side of the lens.

As described herein, in an exemplary embodiment, during the lens formation process the components of the second side 316 may be configured to oppose one or more forces provided during formation of the lens (e.g., a compressive force, a shrinkage force, an expansion force, etc.), for example to secure (e.g., couple, stabilize, etc.) the lens within the receptacle. For example, the top lateral interface 364 may be configured to oppose a first compressive force (e.g., a shrinkage force in a vertical, downward direction, etc.) and the bottom lateral interface 365 may be configured to oppose a second compressive force (e.g., a shrinkage force in a vertical, upward direction, etc.), for example to stabilize (e.g., form, define, etc.) a second lateral portion or side of the lens relative to the second side 316. Further, the front lateral interface 366 may be configured to oppose one or more compressive forces (e.g., a shrinkage force, etc. in a horizontal, rearward or back direction, etc.), for example to stabilize (e.g., form, define, etc.) a front portion (e.g., a lip or ridge, etc.) of the lens relative to the second side 316.

In an exemplary embodiment, the first rear lateral interface 368 is configured to oppose one or more compressive forces (e.g., a shrinkage force, etc. in a horizontal, forward or front direction, etc.), for example to stabilize (e.g., form, define, etc.) a first rear lateral portion of the lens relative to the second side 316. Similarly, in an exemplary embodiment the second rear lateral interface 369 is configured to oppose one or more compressive force (e.g., a shrinkage force, etc. in a horizontal, forward or front direction, etc.), for example to stabilize (e.g., form, define, etc.) a second rear lateral portion of the lens relative to the second side 316. In this sense, the rear lateral interfaces (e.g., the first rear lateral interface 368, the second rear lateral interface 369, etc.) may be configured to facilitate forming one or more connection components of a lens, for example by opposing compressive forces during a lens fabrication process, to facilitate stabilizing a rear lateral portion of the lens relative to the second side 316.

Referring still to FIG. 5, the bottom 318 is shown to include a surface or face, shown as bottom surface 370, and a void or aperture, shown as opening 372 (e.g., as shown in the first receptacle 230). The bottom surface 370 may be defined by and/or a part of the bottom surface 212. The bottom surface 370 may extend from the second end 312 (e.g., toward the first end 310) to the opening 372 (e.g., at or adjacent the first end 310).

According to an exemplary embodiment, the opening 372 extends through the bottom surface 212 of the cover 120, for example to facilitate forming a lens, as described herein. The opening 372 may be defined by one or more walls, surfaces, or faces of a receptacle (e.g., the second rear wall portion 336, the first lateral wall 350, the second lateral wall 360, etc.). For example, the opening 372 may further be defined by a bottom surface or face of the rear protrusion 332 (e.g., the bottom rear interface 338), a bottom surface or face of the first lateral protrusion 352 (e.g., the bottom lateral interface 355, etc.), a bottom surface or face of the second lateral protrusion 362 (e.g., the bottom lateral interface 365), and/or one or more rear or lateral surfaces or faces of the first lateral wall 350 and/or the second lateral wall 360, etc. (e.g., as shown in the first receptacle 230).

According to an exemplary embodiment, the bottom 318 also includes a projection or protrusion, shown as a bottom protrusion 374 (e.g., as shown in the first receptacle 230). The bottom protrusion 374 may extend from the bottom surface 370, for example to form at least one ridge, shelf, or interface. For example, the bottom protrusion 374 may extend from the bottom surface 370 to form a first surface or face, shown as a top face 376, a second surface or face, shown as a medial face 378, and/or a third surface or face, shown as a bottom face 379. The top face 376 may extend from the second end 312 (e.g., toward the first end 310), and the medial face 378 may extend from the top face 376 (e.g., toward the first end 310). In some embodiments, the medial face 378 is angled relative to the top face 376 (e.g., as shown in the first receptacle 230).

As shown in FIG. 5, the bottom protrusion 374 extends a distance beyond the bottom surface 370 (e.g., toward the opening 372), for example such that the medial face 378 extends into and/or toward the opening 372. According to an exemplary embodiment, the bottom protrusion 374 extends beyond the bottom surface 370 (e.g., such that the medial face 378 extends into and/or toward the opening 372, etc.), for example to facilitate forming the bottom face 379.

According to an exemplary embodiment, and as will be described herein, the components of the bottom 318 (e.g., the opening 372, the bottom protrusion 374, the top face 376, the medial face 378, the bottom face 379, etc.) may be arranged to facilitate forming one or more components of a lens (e.g., via an injection molding process, etc.). For example, the components of the bottom 318 may be configured to facilitate forming (e.g., via an injection molding process, etc.) one or more projections, surfaces, and/or voids of a lens. As discussed herein, the lens may be formed by providing (e.g., injecting, etc.) a fabrication material to a receptacle, and once the fabrication material is allowed to form (e.g., harden, solidify, etc.), the components of the bottom 318 facilitate forming associated components of a bottom of the lens.

As described herein, in an exemplary embodiment, during the lens formation process the components of the bottom 318 may be configured to oppose one or more forces provided during formation of the lens (e.g., a compressive force, a shrinkage force, an expansion force, etc.), for example to secure (e.g., couple, stabilize, etc.) the lens within the receptacle. For example, the top face 376 and/or the medial face 378 may be configured to oppose a first compressive force (e.g., a shrinkage force in a vertical, downward direction, etc.) and the bottom face 379 may be configured to oppose a second compressive force (e.g., a shrinkage force in a vertical, upward direction, etc.), for example to stabilize (e.g., form, define, etc.) a bottom portion or side of the lens relative to the bottom 318. Further, the bottom protrusion 374 may be configured to oppose one or more compressive forces (e.g., a shrinkage force, etc. in a horizontal direction, etc.), for example to stabilize (e.g., form, define, etc.) a portion (e.g., a lip or ridge, etc.) of the lens relative to the bottom 318.

As shown in FIG. 5, the top 320 is shown to be or include an opening, void, or aperture. In an exemplary embodiment, the top 320 forms an opening or void in the top surface 210 of the cover 120, for example to facilitate forming a lens, as described herein.

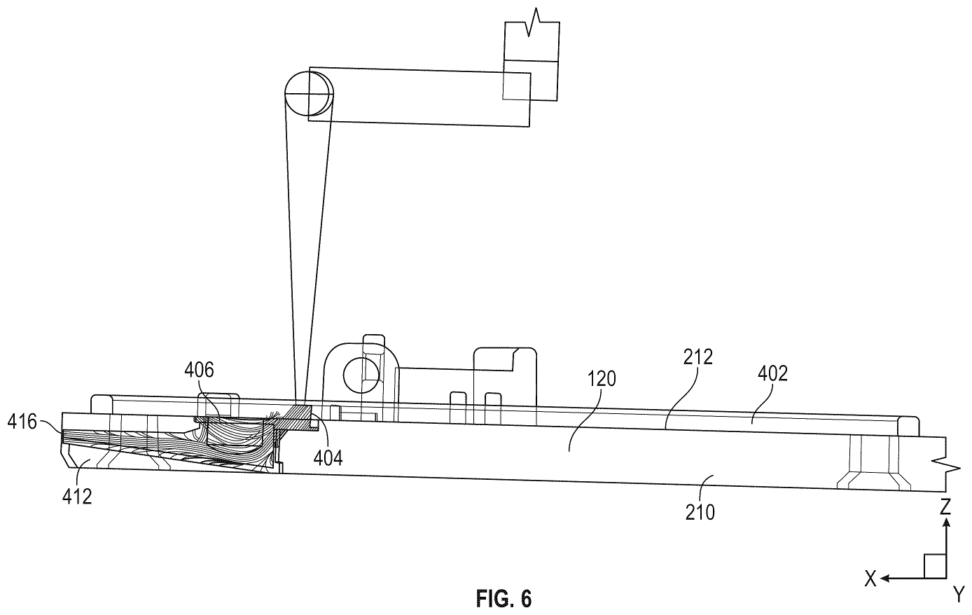

Referring now to FIG. 6, and as discussed herein, the exemplary components of the device 100 (e.g., the cover 120, etc.) may be configured to facilitate forming at least one lens. For example, the components of each receptacle of the lens housing portion 220 (e.g., the components of the receptacles described with reference to FIG. 5, etc.) may be configured to facilitate forming a lens housed therein (e.g., via an injection molding process).

As shown in FIG. 6, the cover 120 may be inverted and placed in a molding device (e.g., an injection molding device, etc.). A first mount or plate, shown as a first plate 402, may be coupled with a surface of the cover 120 (e.g., the bottom surface 212, etc.), for example to stabilize the cover 120 relative to the molding device. As shown in FIG. 6, the first plate 402 may couple the bottom surface 370 of the bottom 318 of each receptacle. Further, the first plate 402 may also include an opening, shown as delivery opening 404, which may be aligned with the opening 372 of the bottom 318 of each receptacle, for example to facilitate delivery of injection molding material (e.g., polycarbonate, plastic, polyester, polypropylene, polyethylene, etc.). As also shown in FIG. 6, and as will be discussed in greater detail herein, the first plate 402 may include an outlet or escape, shown as outlet 406, for example to facilitate removal of injection molding material (e.g., within the cover 120, etc.), for example to facilitate forming one or more components of a lens.

As also shown in FIG. 6, a second mount or plate, shown as a second plate 412, may be coupled with a surface of the cover 120 (e.g., the top surface 210, a top surface of the lens housing portion 220, etc.), for example also to stabilize the cover 120 relative to the molding device. As shown in FIG. 6, the second plate 412 may extend across the top 320 of each receptacle, for example coupling with one or more surfaces (e.g., top surfaces, etc.) of the lateral walls of the receptacles (e.g., the first lateral wall 350, the second lateral wall 360, etc.). The second plate 412 may couple with the one or more surfaces (e.g., of the first lateral wall 350, the second lateral wall 360, etc.) to facilitate forming a cavity within each receptacle (e.g., the first receptacle 230, the second receptacle 232, etc.), for example to facilitate delivery of injection molding material to form a lens. As shown in FIG. 6, the second plate 412 may also couple with one or more surfaces (e.g., the first lateral wall 350, the second lateral wall 360, etc.), which also forming an outlet or escape at each receptacle (e.g., at the opening 342 of each receptacle, etc.), shown as outlet 416. As will be discussed herein, the outlet 416 may be configured to facilitate removal of injection molding material (e.g., within the cover 120, etc.), for example to facilitate forming one or more components of a lens.

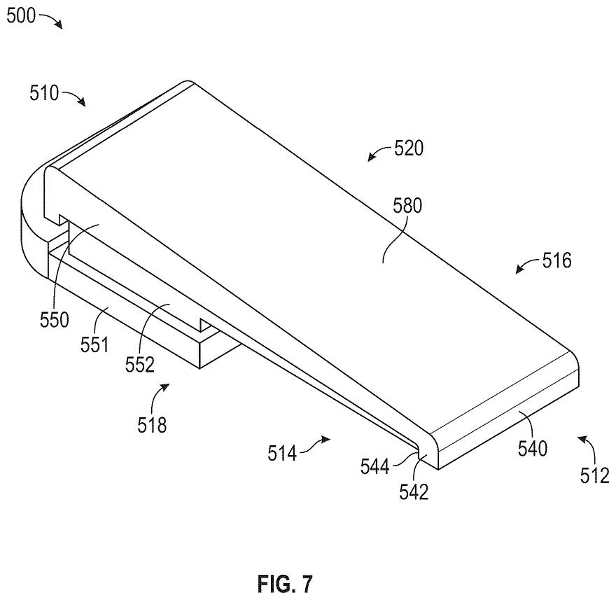

Referring now to FIGS. 7-10, a lens is shown, according to an exemplary embodiment. In an exemplary embodiment, the lens, shown as lens 500, is formed using the components and/or processes described herein. For example, the lens 500 may be formed via a molding process (e.g., injection molding, a single-step injection molding process, etc.) that utilizes one or more components of the cover 120 (e.g., components of a receptacle of the lens housing portion 220, etc.). According to an exemplary embodiment, the lens 500 is integrally formed (e.g., via a molding process, etc.) with one or more components of the housing 102 (e.g., a receptacle of the lens housing portion 220 of the cover 120, etc.), for example to facilitate improved stability, reduce appearance defects, limit fabrication steps, and/or reduce resource consumption in implementing the lens 500 with the housing 102 (e.g., the cover 120, etc.).

In an exemplary embodiment, the lens 500 is a lens of the cover 120 of FIGS. 2-3. For example, the lens 500 may be the first lens 240, the second lens 242, the third lens 244, the fourth lens 246, and/or the fifth lens 248. In this regard, one or more of the components of the lens 500 described herein may be the same or similar to any and/or all of the lenses of the cover 120 described elsewhere herein (e.g., the first lens 240, the second lens 242, the third lens 244, the fourth lens 246, and/or the fifth lens 248).

As shown in FIGS. 7-10, the lens 500 includes a first end, shown as a first end 510, and a second end, shown as a second end 512, opposite the first end 510. In some embodiments, the first end 510 is a rear or back end, and the second end 512 is a front or edge end. The lens 500 further includes a first side, shown as a first side 514, and a second side, shown as a second side 516, opposite the first side 514. In some embodiments, the first side 514 is a first lateral side, and the second side 516 is a second lateral side, opposite the first lateral side. The first side 514 and/or the second side 516 may extend between the first end 510 and the second end 512. The lens 500 also includes a third side, shown as a bottom 518, and a fourth side, shown as a top 520, opposite the bottom 518. The bottom 518 and/or the top 520 may extend between the first end 510 and the second end 512.

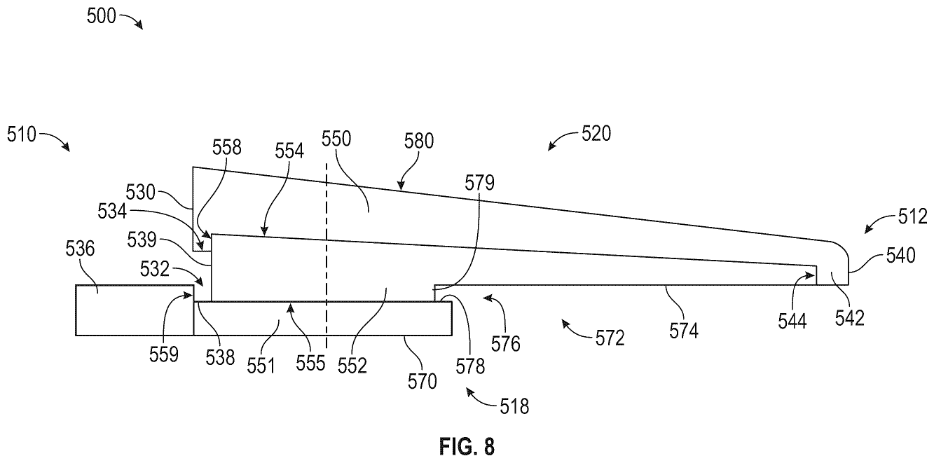

As shown in at least FIGS. 8-10, the first end 510 includes a surface or face, shown as a rear wall, and a void, aperture, opening, or space, shown as a rear interlock aperture 532. The rear wall is shown to include a first rear wall portion 530 and a second rear wall portion 536. The rear interlock aperture 532 may be formed and/or positioned between the first rear wall portion 530 and the second rear wall portion 536. The rear interlock aperture 532 may be defined by a top rear interface 534, a bottom rear interface 538, and a front rear interface 539.

According to an exemplary embodiment, and as described herein, the components of the first end 510 (e.g., the first rear wall portion 530, the rear interlock aperture 532, the second rear wall portion 536, the top rear interface 534, the bottom rear interface 538, the front rear interface 539, etc.) are formed using one or more components of a receptacle (e.g., via an injection molding process, etc.). For example, the one or more components of the first end 510 may be formed by providing (e.g., injecting, etc.) a fabrication material to a receptacle, and allowing the fabrication material to form (e.g., harden, stabilize, solidify, etc.), for example to form the one or more components of the first end 510 described herein.

For example, the rear interlock aperture 532 (e.g., and/or associated top rear interface 534, bottom rear interface 538, front rear interface 539, etc.) may be formed by a space filled by the rear protrusion 332 in a receptacle (e.g., during an injection molding processes, etc.). Similarly, the first rear wall portion 530 may be formed by a space or void provided by the first rear wall portion 330 in a receptacle, and/or the second rear wall portion 536 may be formed by a space or void provided by the second rear wall portion 336 in the receptacle.

As also discussed herein, following the lens formation process the components of the first end 510 may be configured to couple (e.g., interface, engage, etc.) corresponding components of a receptacle, for example to secure (e.g., stabilize, etc.) the lens 500 within the receptacle. For example, the top rear interface 534 may couple (e.g., interface, engage, etc.) the top rear interface 334 of the rear protrusion 332, the bottom rear interface 538 may couple the bottom rear interface 338 of the rear protrusion 332, and/or the front rear interface 539 may couple a surface of the rear protrusion 332, for example to secure (e.g., stabilize, etc.) the lens 500 within the receptacle. Further, a surface of the first rear wall portion 530 may couple (e.g., engage, interface, etc.) a surface of the first rear wall portion 330 of a receptacle, and/or a surface of the second rear wall portion 536 may couple (e.g., engage, interface, etc.) a surface of the second rear wall portion 336, for example to secure (e.g., stabilize, etc.) the lens 500 within the receptacle.

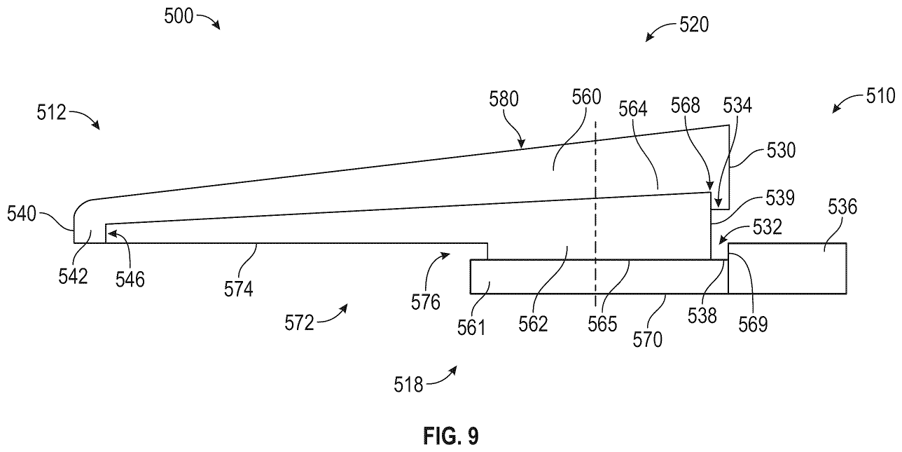

As shown in FIGS. 7-10, the second end 512 includes a surface or face, shown as front face 540. The front face 540 may include a rounded or chamfered portion, which may, for example, be formed via a fabrication process (e.g., injection molding process, etc.), described herein. In some embodiments, the second end 512 includes a protrusion or projection, shown as front projection 542. In an exemplary embodiment, the front projection 542 is defined at least in part by the front face 540. The front projection 542 may further define at least one ridge, shelf, or interface. For example, the front projection 542 may form a first front interface 544 (e.g., as shown in at least FIG. 8) and a second front interface 546 (e.g., as shown in at least FIG. 9).

According to an exemplary embodiment, and as described herein, the components of the second end 512 (e.g., the front projection 542, the first front interface 544, the second front interface 546, etc.) are formed using one or more components of a receptacle (e.g., via an injection molding process, etc.). In some embodiments, the one or more components of the second end 512 may be formed by providing (e.g., injecting, etc.) a fabrication material to a receptacle, and allowing the fabrication material to form (e.g., harden, stabilize, solidify, etc.), for example to form the one or more components of the second end 512 described herein. For example, the front projection 542 (e.g., and/or associated first front interface 544, second front interface 546, etc.) may be formed by a space filled by the first lateral protrusion 352 and/or the second lateral protrusion 362 in a receptacle.

Further, and as also discussed herein, following the lens formation process the components of the second end 512 may be configured to couple (e.g., interface, engage, etc.) corresponding components of a receptacle, for example to secure (e.g., stabilize, etc.) the lens 500 within the receptacle. For example, the first front interface 544 may couple (e.g., interface, engage, etc.) the front lateral interface 356 of the first lateral protrusion 352, and/or the second front interface 546 may couple (e.g., interface, engage, etc.) the front lateral interface 366 of the second lateral protrusion 362, for example to secure (e.g., stabilize, etc.) the lens 500 within the receptacle.

As shown in FIGS. 7-8, the first side 514 includes at least one wall, surface, or face. For example, the first side 514 is shown to include a first lateral wall portion 550 and a second lateral wall portion 551. The first lateral wall portion 550 may have a tapered configuration, for example a tapered configuration when extending from the first end 510 to the second end 512 (e.g., as shown in at least FIG. 8). The second lateral wall portion 551 may be offset from the first lateral wall portion 550. For example, the first lateral wall portion 550 may be positioned at or toward the top 520, and the second lateral wall portion 551 may be positioned at or toward the bottom 518. In an exemplary embodiment, the first lateral wall portion 550 is configured to extend from the first side 514 (e.g., away from the second side 516, away from a central portion of the lens 500, etc.) a first distance, and the second lateral wall portion 551 is configured to extend from the first side 514 a second distance. In some embodiments, the first distance and the second distance are different, for example the first distance may be less than the second distance (e.g., as shown in at least FIG. 7).

In exemplary embodiment, the first side 514 further includes a channel, recess, or groove, shown as channel 552 (e.g., as shown in at least FIGS. 7-8). The channel 552 may be positioned between the first lateral wall portion 550 and the second lateral wall portion 551. In this regard, and as shown in FIGS. 7-8, the channel 552 may separate or divide the first lateral wall portion 550 and the second lateral wall portion 551. According to an exemplary embodiment, the channel 552 is defined by one or more ridges, shelves, and/or interfaces (e.g., of the first lateral wall portion 550, the second lateral wall portion 551, etc.).

For example, the channel 552 may be defined by a top interface 554, a bottom interface 555, a front interface (e.g., the first front interface 544, etc.), a first rear interface 558, and/or a second rear interface 559 (e.g., as shown in at least FIG. 8). The top interface 554 may define a top portion of the channel 552 (e.g., at the first lateral wall portion 550) and the bottom interface 555 may define a bottom portion of the channel 552 (e.g., at the second lateral wall portion 551). The first rear interface 558 may be defined by the first lateral wall portion 550 and the second rear interface 559 may be defined by the second lateral wall portion 551. In an exemplary embodiment, the first rear interface 558 and the second rear interface 559 are offset (e.g., in a vertical direction, in a horizontal direction, etc.).

According to an exemplary embodiment, and as described herein, the components of the first side 514 (e.g., the first lateral wall portion 550, the second lateral wall portion 551, the channel 552, etc.) are formed using one or more components of a receptacle (e.g., via an injection molding process, etc.). For example, the one or more components of the first side 514 may be formed by providing (e.g., injecting, etc.) a fabrication material to a receptacle, and allowing the fabrication material to form (e.g., harden, stabilize, solidify, etc.), for example to form the one or more components of the first side 514 described herein.

For example, the channel 552 (e.g., and/or associated top interface 554, bottom interface 555, first front interface 544, first rear interface 558, and/or second rear interface 559, etc.) may be formed by a space filled by the first lateral protrusion 352 in a receptacle (e.g., during an injection molding process, etc.). Further, the first rear interface 558 (e.g., of the first lateral wall portion 550) may be formed by a space or void provided between the first rear wall portion 330 and the first rear lateral interface 358. Similarly, the second rear interface 559 (e.g., of the second lateral wall portion 551) may be formed by a space or void provided between the second rear wall portion 336 and the second rear lateral interface 359.

As also discussed herein, following the lens formation process the components of the first side 514 may be configured to couple (e.g., interface, engage, etc.) corresponding components of a receptacle, for example to secure (e.g., stabilize, etc.) the lens 500 within the receptacle. For example, the top interface 554 of the channel 552 may couple (e.g., interface, engage, etc.) the top lateral interface 354 of the first lateral protrusion 352, and/or the bottom interface 555 of the channel 552 may couple (e.g., interface, engage, etc.) the bottom lateral interface 355 of the first lateral protrusion 352, for example to secure (e.g., stabilize, etc.) the lens 500 within the receptacle. Further, first rear interface 558 of the channel 552 may couple (e.g., interface, engage, etc.) the first rear lateral interface 358 of the first lateral protrusion 352, and/or the second rear interface 559 of the channel 552 may couple (e.g., interface, engage, etc.) the second rear lateral interface 359 of the first lateral protrusion 352, for example to secure (e.g., stabilize, etc.) the lens 500 within the receptacle.

Referring to FIG. 9, the second side 516 also includes at least one wall, surface, or face. Similar to the first side 514, the second side 516 may include a first lateral wall portion 560 and a second lateral wall portion 561 (e.g., as shown in at least FIG. 9). The first lateral wall portion 560 may have a tapered configuration, for example a tapered configuration when extending from the first end 510 to the second end 512. The second lateral wall portion 561 may be offset from the first lateral wall portion 560. For example, the first lateral wall portion 560 may be positioned at or toward the top 520, and the second lateral wall portion 561 may be positioned at or toward the bottom 518. In an exemplary embodiment, the first lateral wall portion 560 is configured to extend from the second side 516 (e.g., away from the first side 514, away from a central portion of the lens 500, etc.) a first distance, and the second lateral wall portion 561 is configured to extend from the second side 516 a second distance. In some embodiments, the first distance and the second distance are different, for example the first distance may be less than the second distance.

In exemplary embodiment, the second side 516 further includes a channel, recess, or groove, shown as channel 562 (e.g., as shown in at least FIG. 9). The channel 562 may be positioned between the first lateral wall portion 560 and the second lateral wall portion 561. In this regard, and as shown in FIG. 9, the channel 562 may separate or divide the first lateral wall portion 560 and the second lateral wall portion 561. According to an exemplary embodiment, the channel 562 is defined by one or more ridges, shelves, and/or interfaces (e.g., of the first lateral wall portion 560, the second lateral wall portion 561, etc.).

For example, the channel 562 may be defined by a top interface 564, a bottom interface 565, a front interface (e.g., the second front interface 546, etc.), a first rear interface 558, and/or a second rear interface 569 (e.g., as shown in at least FIG. 9). The top interface 564 may define a top portion of the channel 562 (e.g., at the first lateral wall portion 560) and the bottom interface 565 may define a bottom portion of the channel 562 (e.g., at the second lateral wall portion 561). The first rear interface 568 may be defined by the first lateral wall portion 560 and the second rear interface 569 may be defined by the second lateral wall portion 561. In an exemplary embodiment, the first rear interface 568 and the second rear interface 569 are offset (e.g., in a vertical direction, in a horizontal direction, etc.).

According to an exemplary embodiment, and as described herein, the components of the second side 516 (e.g., the first lateral wall portion 560, the second lateral wall portion 561, the channel 562, etc.) are formed using one or more components of a receptacle (e.g., via an injection molding process, etc.). For example, the one or more components of the second side 516 may be formed by providing (e.g., injecting, etc.) a fabrication material to a receptacle, and allowing the fabrication material to form (e.g., harden, stabilize, solidify, etc.), for example to form the one or more components of the second side 516 described herein.

For example, the channel 562 (e.g., and/or associated top interface 564, bottom interface 565, second front interface 546, first rear interface 568, and/or second rear interface 569, etc.) may be formed by a space filled by the second lateral protrusion 362 in a receptacle (e.g., during an injection molding process, etc.). Further, the first rear interface 568 (e.g., of the first lateral wall portion 560) may be formed by a space or void provided between the first rear wall portion 330 and the first rear lateral interface 368. Similarly, the second rear interface 569 (e.g., of the second lateral wall portion 561) may be formed by a space or void provided between the second rear wall portion 336 and the second rear lateral interface 369.

As also discussed herein, following the lens formation process the components of the second side 516 may be configured to couple (e.g., interface, engage, etc.) corresponding components of a receptacle, for example to secure (e.g., stabilize, etc.) the lens 500 within the receptacle. For example, the top interface 564 of the channel 562 may couple (e.g., interface, engage, etc.) the top lateral interface 364 of the second lateral protrusion 362, and/or the bottom interface 565 of the channel 562 may couple (e.g., interface, engage, etc.) the bottom lateral interface 365 of the second lateral protrusion 362, for example to secure (e.g., stabilize, etc.) the lens 500 within the receptacle. Further, first rear interface 568 of the channel 562 may couple (e.g., interface, engage, etc.) the first rear lateral interface 368 of the second lateral protrusion 362, and/or the second rear interface 569 of the channel 562 may couple (e.g., interface, engage, etc.) the second rear lateral interface 369 of the second lateral protrusion 362, for example to secure (e.g., stabilize, etc.) the lens 500 within the receptacle.

Referring still to FIGS. 7-10, the bottom 518 is shown to include at least one wall, surface, or face, shown as a first bottom wall portion 570, and a void or opening, shown as opening 572. The first bottom wall portion 570 may extend from the first end 510 (e.g., toward the second end 512) to the opening 572. In an exemplary embodiment, the opening 572 is defined by a second bottom wall portion 574, which may extend from the second end 512 (e.g., toward the first end 510). In some embodiments, the second bottom wall portion 574 is offset from the first bottom wall portion and/or extends from the second end 512 to overlap with a portion of the first bottom wall portion 570, for example to form a void, aperture, opening, or space, as described herein.

As shown in at least FIGS. 8-9, the bottom 518 further includes a void, aperture, opening, or space, shown as bottom interlock aperture 576. The bottom interlock aperture 576 may extend into the first bottom wall portion 570 (e.g., toward the first end 510, for example to form a void or opening, etc.). In some embodiments, the bottom interlock aperture 576 forms a negative space at the first bottom wall portion 570 (e.g., between the first bottom wall portion 570 and the second bottom wall portion 574). According to an exemplary embodiment, the bottom interlock aperture 576 is defined by at least one ridge, shelf, or interface. For example, the bottom interlock aperture 576 may be defined by at least a bottom interface 578 and a rear interface 579.

According to an exemplary embodiment, and as described herein, the components of the bottom 518 (e.g., second bottom wall portion 574, the bottom interlock aperture 576, etc.) are formed using one or more components of a receptacle (e.g., via an injection molding process, etc.). For example, the one or more components of the bottom 518 may be formed by providing (e.g., injecting, etc.) a fabrication material to a receptacle, and allowing the fabrication material to form (e.g., harden, stabilize, solidify, etc.), for example to form the one or more components of the bottom 518 described herein.

For example, the bottom interlock aperture 576 (e.g., and/or associated bottom interface 578, rear interface 579, etc.) may be formed by a space filled by the bottom protrusion 374 in a receptacle (e.g., during an injection molding process, etc.). As also discussed herein, following the lens formation process the components of the bottom 518 may be configured to couple (e.g., interface, engage, etc.) corresponding components of a receptacle, for example to secure (e.g., stabilize, etc.) the lens 500 within the receptacle. For example, the second bottom wall portion 574 may be configured to couple (e.g., interface, engage, etc.) the top face 376 of the bottom protrusion 374, for example to secure (e.g., stabilize, etc.) the lens 500 within the receptacle. Further, the bottom interface 578 of the bottom interlock aperture 576 may be configured to couple (e.g., interface, engage, etc.) the bottom face 379 of the bottom protrusion 374, for example to secure (e.g., stabilize, etc.) the lens 500 within the receptacle.

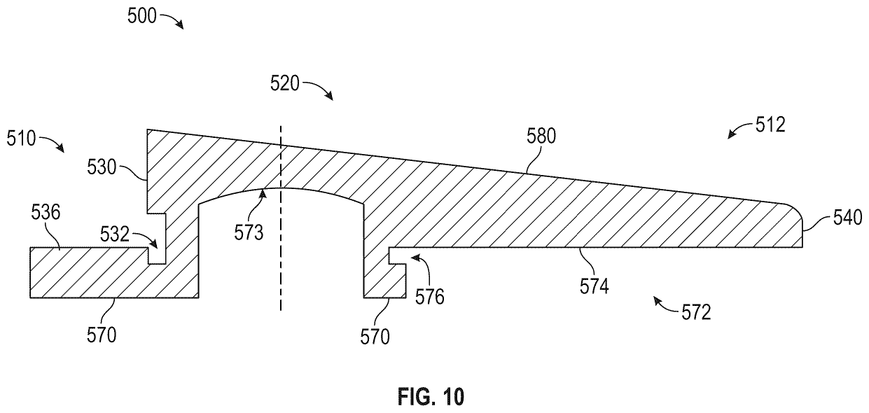

As shown in FIG. 10, the bottom 518 further includes a second void, aperture, opening, or space, shown as opening 573. According to an exemplary embodiment, the opening 573 is formed through the first bottom wall portion 570. The opening 573 may be positioned at a central portion of the first bottom wall portion 570 (e.g., between the first side 514 and the second side 516). According to an exemplary embodiment, the opening 573 is formed as a result of a formation process (e.g., an injection molding process, etc.), as described herein. For example, during formation of the lens 500 material may be removed from a cast or mold (e.g., to facilitate heat dissipation, account for shrinkage or expansion of materials, etc.), which may result in formation of the opening 573.

In an exemplary embodiment, the opening 573 is configured to facilitate providing the lens 500 with one or more characteristics. For example, the opening 573 may facilitate forming one or more components of the lens 500 during a formation process, as described herein. The opening 573 may further facilitate providing the lens 500 with light-scattering, light-emitting, and/or light-transmission properties. In some embodiments, the opening 573 is configured to receive and/or house one or more components. For example, in some embodiments the opening 573 is configured to receive and/or house a light source (e.g., a light-emitting diode (LED), etc.).

Referring still to FIGS. 7-10, the top 520 may include at least one wall, surface, or face, shown as a top wall 580. According to an exemplary embodiment, the top wall 580 extends from the first end 510 to the second end 512. The top wall 580 may be angled or include a slope (e.g., relative to the bottom 518, the first bottom wall portion 570, the second bottom wall portion 574, etc.). For example, and as shown in at least FIGS. 7-10, the top wall 580 may extend at a downward angle (e.g., a negative or decreasing slope, etc.) when extending from the first end 510 to the second end 512.

According to an exemplary embodiment, and as discussed herein, the lens 500 may be formed using a formation process (e.g., a single injection molding process, etc.), in combination with one or more components of a cover (e.g., the cover 120, etc.). For example, components of the lens housing portion 220 of the cover 120 (e.g., components of each receptacle, etc.), may be configured to oppose one or more forces provided during formation of the lens (e.g., a compressive force, a shrinkage force, an expansion force, etc.), for example to facilitate formation of components of the lens (e.g., projections, protrusions, voids, apertures, etc.) and/or to secure (e.g., couple, stabilize, etc.) the lens within the receptacle. In this regard, the design of the one or more components of the cover, along with the formation process described herein, are able to address the potential issues or drawbacks posed by traditional fabrication and/or machining techniques.

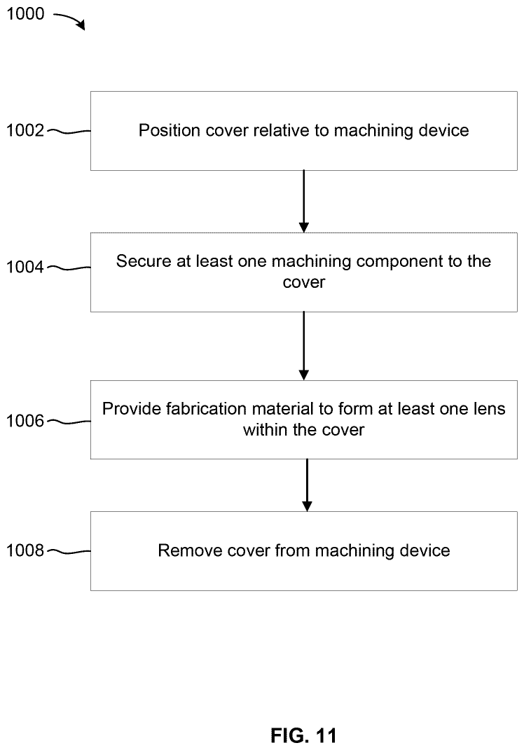

Referring now to FIG. 11, a process 1000 of forming a component of a device is shown, according to an exemplary embodiment. In an exemplary embodiment, the process 1000 is implemented to form at least one lens of a cover of a servo drive device. According to an exemplary embodiment, the process 1000 is implemented to form the cover 120 having a plurality of lenses 500 formed within a plurality of receptacles, as discussed.

At step 1002, a cover is positioned relative to a machining device, according to an exemplary embodiment. In an exemplary embodiment, the cover 120 is positioned relative to a molding device (e.g., an injection molding device). For example, the cover 120 may be inverted and placed relative to a molding device (e.g., as shown in at least FIG. 6).

At step 1004, at least one machining component is secured to the cover, according to an exemplary embodiment. For example, a first plate and/or a second plate may be secured to one or more surfaces of the cover 120. As discussed with reference to FIG. 6, in an exemplary embodiment a first plate (e.g., the first plate 402) is coupled with the bottom surface 212 of the cover 120, for example to stabilize the cover 120 relative to the molding device. Further, the first plate 402 may couple the bottom surface 370 of the bottom 318 of each receptacle, such that an opening in the first plate 402 (e.g., a delivery opening, the delivery opening 404, etc.) is aligned with the opening 372 of the bottom 318 of each receptacle.

As also discussed with reference to FIG. 6, in an exemplary embodiment a second plate (e.g., the second plate 412, etc.) is coupled with the top surface 210 of the cover 120, for example to stabilize the cover 120 relative to the molding device. The second plate 412 may extend across the top 320 of each receptacle, for example coupling with one or more surfaces (e.g., top surfaces, etc.) of the lateral walls of the receptacles (e.g., the first lateral wall 350, the second lateral wall 360, etc.) to form a cavity within each receptacle.

At step 1006, fabrication material is provided to the cover, according to an exemplary embodiment. According to an exemplary embodiment, the fabrication material is provided (e.g., injected) through a delivery opening (e.g., the delivery opening 404 in the first plate 402) and through the opening 372 of the bottom 318 of the receptacle, for example into the cavity formed between the cover 120 and the plates. According to an exemplary embodiment, the fabrication material is provided through the opening 372 of the bottom 318 of the receptacle, and fills the cavity formed between the cover 120 and the plates (e.g., the first plate 402, the second plate 412, etc.) by moving from the opening 372 and toward the opening 342 (e.g., of each receptacle and/or formed by the cover 120 and the plates, etc.). In an exemplary embodiment, by directing the flow of the fabrication material within the cavity between the cover 120 and the plates (e.g., from the opening, toward the opening 342) the formation characteristics of the fabrication material (e.g., shrinkage, longitudinal shrinkage, expansion, etc.) are accounted for, thereby facilitating better connections between the fabrication material (e.g., the lens 500) and the material of the cover 120 (e.g., metal, etc.).

In some embodiments, the fabrication material is provided while the cover 120 has predetermined characteristics. For example, the fabrication material may be provided while the cover 120 is at ambient temperature, thereby further facilitating heat dissipation during the formation process. Further, in some embodiments the fabrication material is provided with predetermined characteristics. For example, by providing the injection material in a liquid state, the injection material is able to move to spaces within the cavity between the cover 120 and the plate, thereby accounting for difficult geometric configurations, facilitating formation of connecting components (e.g., of the lens 500, etc.), and/or compensating for potential defects in one or more components of the cover 120 (e.g., machining or manufacturing defects, painting defects, etc.).

According to an exemplary embodiment, the fabrication material is a transparent plastic material (e.g., polycarbonate, etc.). However, in other embodiments, the fabrication material is another suitable material (e.g., plastic, polyester, polypropylene, polyethylene, etc.). In some embodiments, the fabrication conditions are compatible with one or more characteristics of the fabrication material and/or the component that receives the fabrication material (e.g., the cover, etc.). For example, the fabrication conditions (e.g., temperature, pressure, injection flow rate, injection speed, heating and/or cooling conditions, moisture and/or humidity levels, etc.) are compatible with the characteristics of the fabrication material (e.g., polycarbonate, etc.) and/or the component that receives the cover (e.g., material characteristics, etc.).

At step 1008, the cover is removed from the machining device, according to an exemplary embodiment. In an exemplary embodiment, following injection of the fabrication material, the fabrication material may be allowed to set (e.g., harden, cool, etc.). As described herein, as the fabrication material forms (e.g., stabilizes, hardens, etc.), one or more components of the cover 120 may be configured to oppose one or more forces (e.g., compressive forces, shrinkage forces, expansion forces, etc.), for example to form components of the lens 500 described herein. Further, with the fabrication material set, the fabrication material forms the lens 500 described herein with connections to stabilize (e.g., couple, engage, interface, etc.) the lens 500 relative to a receptacle of the cover 120. According to an exemplary embodiment, the lens 500 is integrated within the cover 120. With the lens 500 in the cover 120, the cover can be removed from the machining device, and integrated as part of the housing 102 of the device 100, as described herein.

According to an exemplary embodiment, the process 1000 is configured to be implemented to form a plurality of lenses within the cover 120. For example, the process 1000 may be implemented to form the lenses 240-248 (e.g., within the receptacles 230-238) within the cover 120 (e.g., as shown in at least FIGS. 2-3). The process 1000 may be implemented to simultaneously form the lenses 240-248. Further, the components of the cover 120 and/or the process 1000 described herein may be configured to form a plurality of lenses, which are separated and reduce light leakage.

As described herein, advantageously the components of the cover and/or the fabrication process (e.g., the injection molding process) described herein are configured to produce lenses (e.g., the lens 500) that are integrated with a housing cover (e.g., the cover 120). Advantageously, the fabrication process (e.g., via injection molding, etc.) allows for the delivery of fabrication material in a way that results in the formation of physical components, which allow for various connections between the lenses and the cover (e.g., the receptacles, etc.). For example, the systems and methods described herein result in the lens 500 having a rear interlock interface and/or interlock aperture (e.g., the top rear interface 534, the rear interlock aperture 532) and a bottom interlock aperture (e.g., the bottom interlock aperture 576), which receive components of the receptacle to connect the lens 500 to the receptacle. Advantageously, these features offer improve stability and/or sealing of components relative to traditional fabrication techniques.

### Configuration of Exemplary Embodiments

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

It is important to note that any element disclosed in one embodiment may be incorporated or utilized with any other embodiment disclosed herein. For example, the lens of the exemplary embodiment described with reference to at FIGS. 7-10 may be incorporated in the cover 120 of the exemplary embodiment described with reference to at least FIGS. 1-4. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An industrial device comprising:
a housing defining a cavity, the housing comprising:
a cover comprising a first surface, a second surface opposite the first surface, and a lens housing portion extending between the first surface and the second surface, the lens housing portion including at least one receptacle to house at least one lens, wherein the at least one receptacle comprises:
a first end and a second end opposite the first end, the first end comprising a rear wall and a rear protrusion extending from the rear wall to form a top rear interface, the top rear interface configured to oppose a first compressive force during formation of the at least one lens to secure the at least one lens within the at least one receptacle; and
a first side comprising a first lateral wall and a first lateral protrusion extending from the first lateral wall to form a first rear lateral interface, the first rear lateral interface configured to oppose a second compressive force during the formation of the at least one lens to secure the at least one lens within the at least one receptacle.

2. The industrial device of claim 1, wherein the first lateral protrusion extends from the first lateral wall to form a first front lateral interface, the first front lateral interface configured to oppose a third compressive force during the formation of the at least one lens to secure the at least one lens within the at least one receptacle, wherein the second compressive force and the third compressive force are in opposing directions.

3. The industrial device of claim 2, wherein the rear protrusion extends from the rear wall to form a bottom rear interface, the bottom rear interface configured to oppose a fourth compressive force during the formation of the at least one lens to secure the at least one lens within the at least one receptacle, wherein the first compressive force and the fourth compressive force are in opposing directions.

4. The industrial device of claim 1, wherein the first lateral protrusion extends from the first lateral wall to form a top lateral interface, the top lateral interface configured to oppose a third compressive force during the formation of the at least one lens to secure the at least one lens within the at least one receptacle, wherein the top lateral interface is angled relative to the first rear lateral interface.

5. The industrial device of claim 1, wherein the first lateral protrusion extends from the first lateral wall to form a bottom lateral interface opposite the top lateral interface, the bottom lateral interface configured to oppose a third compressive force during the formation of the at least one lens to secure the at least one lens within the at least one receptacle, wherein the wherein the first compressive force and the third compressive force are in opposing directions.

6. The industrial device of claim 1, wherein the cover further comprises:
a second side comprising a second lateral wall and a second lateral protrusion extending from the second lateral wall to form a second rear lateral interface, the second rear lateral interface configured to oppose a third compressive force during the formation of the at least one lens to secure the at least one lens within the at least one receptacle, wherein the second compressive force and the third compressive force are aligned.

7. The industrial device of claim 6, wherein the second lateral protrusion extends from the second lateral wall to form a second front lateral interface, the second front lateral interface configured to oppose a fourth compressive force during the formation of the at least one lens to secure the at least one lens within the at least one receptacle, wherein the third compressive force and the fourth compressive force are in opposing directions.

8. The industrial device of claim 1, wherein the cover further comprises:
a bottom having a bottom having a bottom surface, a bottom protrusion, and an opening, the bottom protrusion extending from the bottom surface and to the opening to form a bottom face, the bottom face configured to oppose a third compressive force during the formation of the at least one lens to secure the at least one lens within the at least one receptacle, wherein the third compressive force and the first compressive force are in opposing directions.

9. The industrial device of claim 8, wherein the opening extends through the second surface and is configured to receive a fabrication material during the formation of the at least one lens to facilitate forming the at least one lens within the at least one receptacle.

10. The industrial device of claim 1, wherein the at least one lens is formed by providing a fabrication material to the at least one receptacle via a single-step injection molding process.

11. The industrial device of claim 10, wherein the at least one lens is one of a plurality of lenses and the at least one receptacle is one of a plurality of receptacles, wherein each of the plurality of receptacles is configured to house one lens of the plurality of lenses, wherein each of the plurality of lenses is formed by providing fabrication material to each of the plurality of receptacles via the single-step injection molding process.

12. A lens for an industrial device formed via an injection molding process, the lens comprising:
a first end and a second end opposite the first end, the first end comprising a first rear wall portion, a second rear wall portion, and a rear interlock aperture between the first rear wall portion and the second rear wall portion, the rear interlock aperture formed during the injection molding process, and the rear interlock aperture configured to receive a rear protrusion of a receptacle of the industrial device to secure the lens within the receptacle; and
a first side comprising a first lateral wall portion, a second lateral wall portion, and a channel between the first lateral wall portion and the second lateral wall portion, the channel formed during the injection molding process, and the channel configured to receive a lateral protrusion of the receptacle of the industrial device to secure the lens within the receptacle.

13. The lens of claim 12, wherein the rear interlock aperture is defined by a first rear interface of the first rear wall portion, the first rear interface of the first rear wall portion configured to couple a rear lateral interface of the lateral protrusion of the receptacle to secure the lens within the receptacle.

14. The lens of claim 12, wherein the channel is defined by a front interface of the first lateral wall portion, the first front interface of the first lateral wall portion configured to couple a front lateral interface of the lateral protrusion of the receptacle to secure the lens within the receptacle.

15. The lens of claim 12, wherein the rear interlock aperture is defined by a top rear interface of the first rear wall portion and the channel is defined by a top lateral interface of the first lateral wall portion, the top rear interface configured to couple a top rear interface of the rear protrusion of the receptacle and the top lateral interface configured to couple a top lateral interface of the lateral protrusion of the receptacle to secure the lens within the receptacle.

16. The lens of claim 12, further comprising:
a bottom comprising a first bottom wall portion, a second bottom wall portion, and a bottom interlock aperture positioned between the first bottom wall portion and the second bottom wall portion, the bottom interlock aperture formed during the injection molding process, and the bottom interlock aperture configured to receive a bottom protrusion of the receptacle of the industrial device to secure the lens within the receptacle.

17. The lens of claim 12, wherein the lens is formed of a transparent plastic, and wherein the injection molding process is a single-step injection molding process.

18. A method of forming at least one lens of a cover of an industrial device, the method comprising:
positioning the cover relative to at least one plate of a machining device, wherein the at least one plate comprises a delivery opening configured to be aligned with an opening in a bottom surface of the cover;
securing the at least one plate relative to the cover;
providing fabrication material to form at least one lens within the cover, wherein providing the fabrication material includes injecting the fabrication material through the delivery opening and the opening in the bottom surface of the cover to a cavity formed between the cover and the at least one plate;
allowing the fabrication material to form, wherein during formation of the fabrication material the fabrication material causes one or more compressive forces to be applied to one or more surfaces of the cover, the one or more surfaces configured to oppose the one or more compressive forces to form the at least one lens and secure the at least one lens relative to the cover; and
removing to cover from the at least one plate.

19. The method of claim 18, wherein allowing the fabrication material to for the at least one lens includes forming the at least one lens comprising:
a first end and a second end opposite the first end, the first end comprising a first rear wall portion, a second rear wall portion, and a rear interlock aperture between the first rear wall portion and the second rear wall portion, the rear interlock aperture configured to receive a rear protrusion of a receptacle of the cover to secure the lens within the receptacle.

20. The method of claim 19, wherein allowing the fabrication material to for the at least one lens includes forming the at least one lens comprising:
a first side comprising a first lateral wall portion, a second lateral wall portion, and a channel between the first lateral wall portion and the second lateral wall portion, the channel configured to receive a lateral protrusion of the receptacle of the cover to secure the lens within the receptacle.
